(19) United States
(12) Patent Application Publication
(10) Pub. No.: US 2026/0327989 A1
(43) Pub. Date: Oct. 22, 2026

(54) SELF-CLEANING RAIN GUTTER SYSTEM FOR AUTOMATED DEBRIS REMOVAL

(71) Applicant: Mirza Faizan, Plano, TX (US)

(72) Inventors: Mirza Faizan, Plano, TX (US); Rohan Vanama, Plano, TX (US); Tarik Syed, Plano, TX (US); Mohammed Kaamil Shadab, Plano, TX (US); Omar Mahasoom, Plano, TX (US); Taarush Adhikari, Plano, TX (US); Ishaaq Mohammed Ali, Plano, TX (US); Gautam Surapaneni, Plano, TX (US); Akshara Kommidi, Plano, TX (US); Simran Babaria, Plano, TX (US); Arjun Kommidi, Plano, TX (US); Sarah Francis, Plano, TX (US); Aaina Mitchell, Plano, TX (US); Arjun Sriram, Plano, TX (US); Arjun Yerramchetty, Plano, TX (US); Saadia Asaf, Aligarh (IN); Mansoor Hasan Khan, Aligarh (IN)

(21) Appl. No.: 19/184,677

(22) Filed: Apr. 21, 2025

(51) Int. Cl. E04D 13/076; F03G 1/06; F16H 37/12; G05B 15/02

(52) U.S. Cl. CPC E04D 13/076; F03G 1/06; F16H 37/122; G05B 15/02

(57) ABSTRACT

Disclosed is a self-cleaning gutter system to remove debris from a rain gutter. The system features a mesh plate positioned over the gutter to allow water to pass through while blocking debris. A motor, operatively connected to a first gear and rack mechanism, stretches a tension spring to store potential energy. The system also includes a second gear and rack mechanism connected to the mesh plate. A ratchet mechanism temporarily locks the second rack while the tension spring accumulates energy. Once a predetermined tension is reached, the ratchet releases, allowing the spring's stored energy to abruptly move the second rack linearly. This motion rotates the second gear, flipping the mesh plate from a first position to a second position, effectively dislodging debris. A processor controls the motor's activation, ensuring efficient operation and periodic cleaning to maintain uninterrupted water flow.

### TECHNICAL FIELD

This disclosure relates to a gutter maintenance system. More specifically, it concerns to a self-cleaning rain gutter system to remove debris from a rain gutter automatically.

### BACKGROUND

Rain gutters are integral to building maintenance, serving as a channel to divert rainwater from roofs to a designated drainage area. By guiding water away from walls, foundations, and landscaping, gutters play a crucial role in protecting the structural integrity of buildings. Properly functioning gutters help prevent erosion, basement flooding, mold growth, and water damage to walls and foundations. However, the effectiveness of gutters can be significantly compromised by clogging, a common problem that arises from the accumulation of debris such as leaves, twigs, dirt, and other organic materials.

Debris buildup in gutters restricts water flow, often leading to overflows during heavy rainfall. This overflow can result in various issues, including water pooling around the foundation, which weakens structural elements and may cause cracks. Clogged gutters can also lead to water backing up onto the roof, which may seep under shingles and cause leaks, rot, and mold growth within the roof structure and interior walls. Over time, these issues can necessitate costly repairs, create health hazards from mold, and damage a property's exterior and interior. The present invention fulfills this need by providing an automated self-cleaning gutter system that operates without manual intervention.

### SUMMARY

In an embodiment, a self-cleaning rain gutter system for removing debris from a rain gutter comprises a mesh plate positioned over the rain gutter to prevent debris from entering the rain gutter while allowing water to pass through. The self-cleaning rain gutter system further comprises a motor operatively connected to the mesh plate and a tension spring. The self-cleaning rain gutter system has a first gear and rack mechanism, comprising a first gear and a first rack, such that the first gear and rack mechanism is coupled to the motor via the first gear and coupled to a first end of the tension spring via the first rack. The first gear and rack mechanism converts rotational motion of the motor into linear motion to stretch the tension spring and store potential energy. The self-cleaning rain gutter system further comprises a second gear and rack mechanism comprising a second gear and a second rack, such that the second gear and rack mechanism is coupled to the mesh plate via the second gear and coupled to a second end of the tension spring via the second rack. The second gear and rack mechanism converts linear motion from the tension spring into rotational motion of the second gear to rotate the mesh plate. The self-cleaning rain gutter system comprises a ratchet mechanism operatively connected to the second rack, such the ratchet mechanism temporarily locks the second rack in place as the tension spring is stretched by the first gear and rack mechanism, thereby preventing the movement of the second rack while the tension spring accumulates potential energy. The ratchet mechanism releases the second rack upon reaching a predetermined tension in the tension spring, thereby allowing the stored energy to be released abruptly to create a sudden linear motion in the second rack, which rotates the second gear and flips the mesh plate from a first position to a second position, thereby dislodging debris from the mesh plate. The self-cleaning rain gutter system further comprises a processor configured to activate the motor to initiate the stretching of the tension spring, such that upon activation by the processor, the motor rotates the first gear and rack mechanism, which stretches the tension spring to accumulate potential energy, and upon release by the ratchet mechanism, the tension spring contracts to create a sudden linear movement in the second rack, flipping the mesh plate to dislodge the debris.

In an embodiment, the self-cleaning rain gutter system further comprises an automated rain gauge that includes a container positioned to collect rainwater and a funnel directing the collected rainwater from the container to a first sensor. The first sensor detects the amount of rain and output information associated with the amount of rain to the processor.

In another embodiment, the processor activates the motor based on the detected amount of rain is greater than a threshold amount of rain.

In another embodiment, the self-cleaning gutter system further comprises a timer operatively connected to the processor, such that the timer periodically signals the processor to activate the motor at set intervals, thereby ensuring regular flipping of the mesh plate to dislodge debris from the gutter even when rain is not detected.

In an embodiment, the processor activates the motor at the set intervals signalled by the timer.

In an embodiment, the processor activates the motor based on a user input.

In an embodiment, the self-cleaning rain gutter system comprises an alarm device that emits an audio alert when the mesh plate is unable to flip due to excessive weight from accumulated debris.

In an embodiment, the self-cleaning rain gutter system comprises a second sensor that determines whether the mesh plate is in the first position or the second position.

In an embodiment, the self-cleaning rain gutter system comprises a display device located within a user's premises. Further, the processor also controls the display device to display whether the mesh plate is in the first position or the second position.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a block diagram of a self-cleaning rain gutter system, in accordance with an embodiment of the present disclosure.

FIG. 2 illustrates exemplary scenarios of a mesh plate in a first position, in accordance with an embodiment of the present disclosure.

FIG. 3 illustrates an exemplary scenario of a mesh plate in a second position, in accordance with an embodiment of the present disclosure.

FIG. 4 illustrates ratchet mechanism in the self-cleaning rain gutter system of FIG. 1, in accordance with an embodiment of the present disclosure.

FIG. 5 illustrates operational configurations of a rack and a pawl in the ratchet mechanism of FIG. 4, in accordance with an embodiment of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

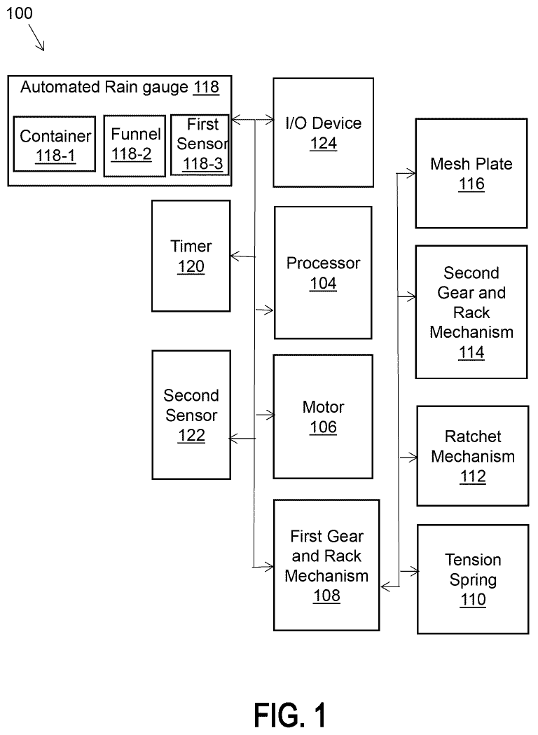

FIG. 1 illustrates a block diagram of a self-cleaning rain gutter system, in accordance with an embodiment of the present disclosure. With reference to FIG. 1, there is shown a block diagram of a self-cleaning rain gutter system 100. The self-cleaning rain gutter system 100 may include a processor 104, a motor 106, a first gear and rack mechanism 108, a tension spring 110, a ratchet mechanism 112, a second gear and rack mechanism 114, a mesh plate 116, an automated rain gauge 118, a timer 120, a second sensor 122, and input/output (I/O) devices 124. In an example, the automated rain gauge 118 may include a container 118-1, a funnel 118-2, and a first sensor 118-3. In an example, the first gear and rack mechanism 108 may include a first gear and a first rack. In an example, the second gear and rack mechanism 114 may include a second gear and a second rack.

The processor 104 manages the entire cleaning operation based on environmental conditions and user inputs. The processor 104 integrates inputs from multiple sensors, user interfaces, and timing mechanisms to ensure optimal operation and timing of the debris-clearing functions.

In an embodiment, the processor 104 receives signals from the automated rain gauge 118, which detects rainfall levels using the container 118-1, the funnel 118-2, and the first sensor 118-3. When the rain gauge indicates rainfall above a set threshold, the first sensor 118-3 sends a signal to the processor 104, prompting it to activate the self-cleaning rain gutter system. This ensures the gutter is cleared of debris before or during significant rainfall, preventing blockages that could cause water overflow or damage.

The timer 120 is connected to the processor 104 to provide regular, periodic signals that activate the cleaning mechanism at set intervals. This feature allows to clear debris from the gutter even during dry periods when there is no rainfall. By operating periodically, the self-cleaning rain gutter system minimizes the risk of build-up over time, enhancing the gutter's effectiveness and reducing manual maintenance.

Additionally, the processor 104 may also accept input from one or more of the I/O devices 124, which may include user interfaces located in accessible areas, such as inside the house. Through these I/O devices 124, users can manually activate the system or modify settings, such as adjusting the timer intervals or setting specific parameters for the rain gauge threshold. The processor 104 may also display the operational status of the system, such as the position of the mesh plate 116 or any alerts if the mesh plate encounters an obstruction or excessive debris weight.

The processor 104 also coordinates with the second sensor 122 to determine the position of the mesh plate 116. When the motor 106 is activated and the mesh plate is flipped to dislodge debris, the second sensor 122 provides feedback to the processor 104, confirming whether the operation was successfully completed and whether the mesh plate 116 has returned to its initial position.

In the event that the mesh plate 116 is unable to flip due to excessive weight from accumulated debris, the processor 104 triggers an alarm device to alert the user through an audio or visual signal, enabling prompt manual intervention.

Therefore, the processor 104 intelligently manages the self-cleaning gutter system by integrating data from rain and position sensors, controlling the motor activation based on pre-set conditions or manual input, and providing real-time status and alerts to the user through the I/O devices 124. This enables efficient, autonomous cleaning of the rain gutter, optimizing water drainage and minimizing the risk of clogs.

The processor 104 may include suitable logic, circuitry, and interfaces that may be configured to execute program instructions associated with a set of operations to be executed to determine weight distribution, provide the output signal or control the speaker, the display screen, or the haptic device. The processor 104 may include one or more processing units, which may be implemented as an integrated processor or a cluster of processors that perform the functions of the one or more processing units, collectively. The processor 104 may be implemented based on a number of processor technologies known in the art. Example implementations of the processor 104 may include, but are not limited to, an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The motor 106 in the self-cleaning gutter system operates by driving the mechanical components responsible for stretching the tension spring 110 and enabling the debris-clearing process. The motor 106 is operatively connected to the first gear and rack mechanism 108, which serves as a critical intermediary for translating the motor's rotational motion into linear motion.

Upon receiving a control signal from the processor 104, the motor 106 initiates rotation of the first gear within the first gear and rack mechanism 108. This rotational motion is transferred to the first rack, a linear component configured to move along a predefined path. As the first gear turns, the teeth of the first gear engage with the corresponding teeth of the first rack, causing the first rack to move linearly.

This linear motion of the first rack directly acts upon the tension spring 110. As the first rack moves, it pulls on the tension spring 110, causing it to stretch and accumulate potential energy.

This process continues until the ratchet mechanism 112 operatively connected to the second gear and rack mechanism 114, temporarily locks the system. The temporary locking of the second gear and rack mechanism 114 by the ratchet mechanism 112 ensures the tension spring 110 remains in a stretched state, storing the potential energy needed for the abrupt release. The ratchet mechanism prevents unintended movement of the second rack during this stage, maintaining system stability.

The controlled co-ordination of the motor 106 and the ratchet mechanism 112 ensures precise and consistent loading of the tension spring, avoiding overloading while optimizing energy storage for effective operation. This mechanism, controlled by the processor 104, integrates seamlessly with other system components to enable autonomous and reliable debris removal.

The tension spring 110 accumulates and release potential energy to facilitate the flipping motion of the mesh plate 116. It is strategically positioned within the self-cleaning rain gutter system, with one end securely coupled to the first gear and rack mechanism 108 and the other end connected to the second gear and rack mechanism 114.

At one end, the tension spring 110 is attached to the first rack, which is part of the first gear and rack mechanism 108. When the motor 106 receives control signals from the processor 104, it rotates the first gear, driving the first rack in a linear motion. As the first rack moves, it stretches the tension spring 110, gradually increasing the spring's length. This stretching process stores potential energy within the tension spring 110. The extent of the stretch is controlled to ensure optimal energy storage without exceeding the spring's mechanical limits. In an embodiment, the user may control the extent of stretch of the tension spring 110 by providing an input to the processor 104 which, in turn, controls the rotational movement of the motor 106. More the number of rotations of a shaft 134 of the motor 106 which is coupled to the first gear, more will be the extent of stretch of the tension spring 110, hence the higher tension in the tension spring 110. Higher tension in the tension spring 110 results in the mesh plate 116 being flipped with greater force, thus easing the removal of debris from the mesh plate 116.

The other end of the tension spring 110 is coupled to the second rack, which is part of the second gear and rack mechanism 114. This connection is critical for translating the stored potential energy into mechanical action. The ratchet mechanism 112 temporarily locks the second rack in place during the spring-stretching phase, ensuring that the accumulated energy remains stored and the second gear does not rotate prematurely.

As the motor-driven first gear and rack mechanism 108 stretches the tension spring 110, the spring accumulates energy. The stored potential energy in the tension spring 110 is then rapidly converted into linear motion of the second rack, which drives the second gear to rotate. This rotation flips the mesh plate 116, dislodging debris effectively.

By coupling the tension spring 110 to both the first and second gear and rack mechanisms, the system ensures a seamless transfer of energy from the motor 106 to the mesh plate 116, enabling precise and efficient operation of the self-cleaning mechanism.

The ratchet mechanism 112 regulates the operation of the second gear and rack mechanism 114 by ensuring precise control over the release of energy stored in the tension spring 110. The ratchet mechanism 112 locks the second rack during the spring-loading phase and releasing it at the appropriate moment to facilitate the flipping motion of the mesh plate 116.

The ratchet mechanism 112 is operatively connected to the second rack, which is part of the second gear and rack mechanism 114. This connection ensures that the second rack remains immobilized during the spring-loading phase, even as the first gear and rack mechanism 108 stretches the tension spring 110. By holding the second rack in a fixed position, the ratchet mechanism prevents premature motion of the second gear, thereby avoiding unintended or inefficient operation of the mesh plate 116.

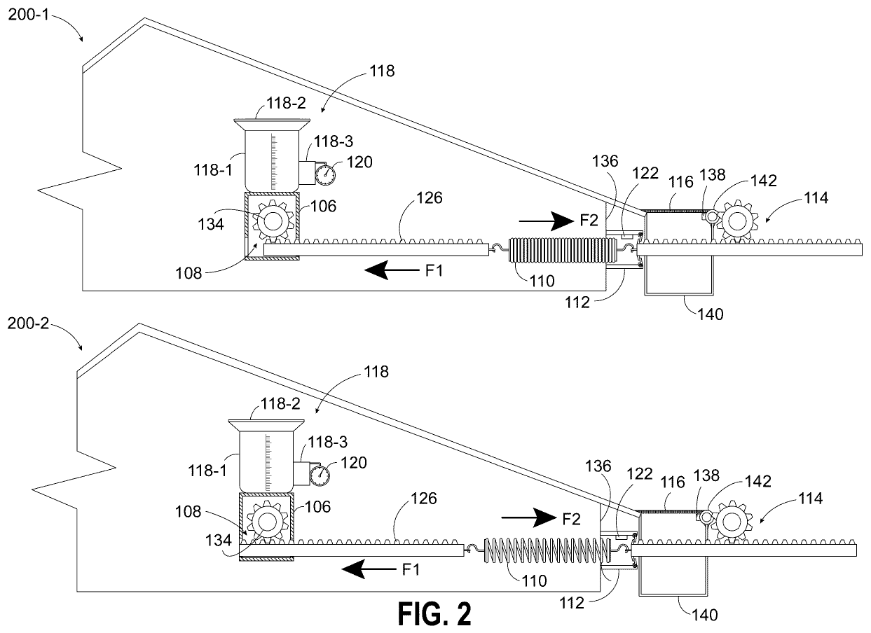

The ratchet mechanism 112 itself is supported by a rigid frame or bracket 144, which is firmly mounted to the structural wall 136 or the gutter frame (not explicitly shown in FIG. 1 but implied by its functionality). The description of the ratchet mechanism 112 being mounted to the structural wall 136 can be found in the description of FIGS. 2, 3, and 4. This support ensures that the ratchet mechanism 112 remains in a fixed position, providing a stable and reliable locking point for the second rack.

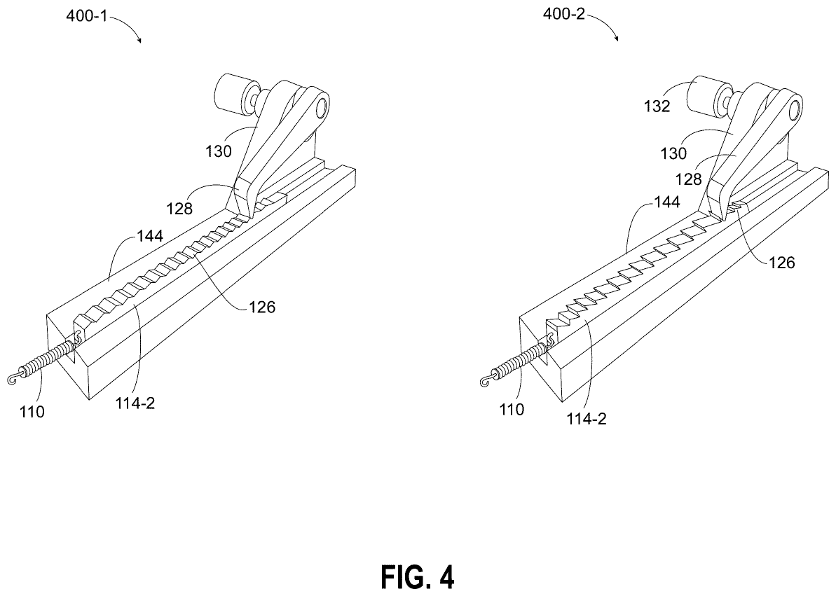

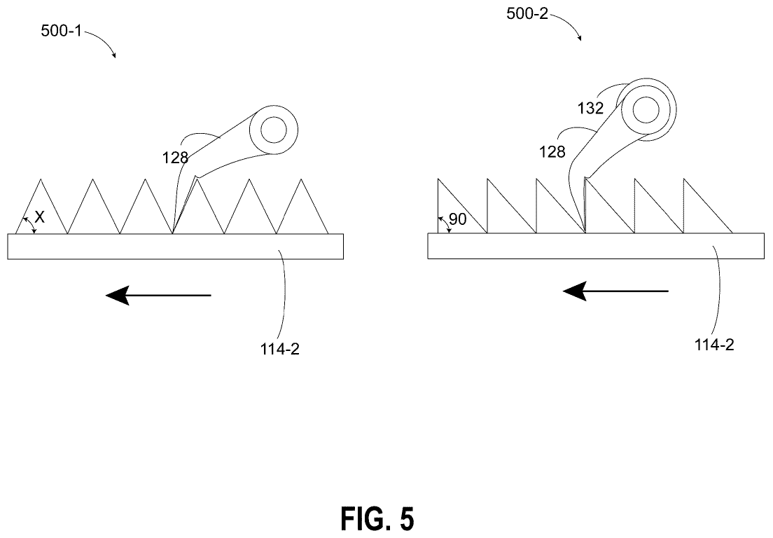

The ratchet mechanism 112 includes a pawl or a ratchet bar 128 and a mounting base 130. The ratchet mechanism 112 uses a series of teeth 126 or notches in the second rack 114-2 as locking elements to lock the pawl 128. The description of locking mechanism of the pawl 128 with the teeth 126 of the second rack 114-2 can be found further in the description of FIGS. 4 and 5.

As the tension spring 110 is stretched by the action of the first gear and rack mechanism 108, the pawl or ratchet bar 128 securely locks the second rack in place. This ensures that the second gear remains stationary, allowing the spring to accumulate the maximum amount of potential energy without any energy loss due to unintended movement. In an embodiment, the ratchet mechanism 112 may be a mechanical trigger that automatically releases the second rack when the spring tension reaches a critical threshold.

Upon release, the stored potential energy in the tension spring 110 is suddenly converted into linear motion of the second rack. This rapid motion drives the second gear, creating a rotational force that flips the mesh plate 116. The abrupt release of energy ensures a swift and forceful flipping action, effectively dislodging accumulated debris from the mesh plate.

When the second rack is driven forward during the cleaning cycle, the pawl 128 temporarily disengages as the force F₁ overcomes the resistance F₂ and the spring's potential energy is released. Once the cleaning cycle is complete, the tension spring 110 retracts, pulling the second rack back to its starting position During this return motion, the angled shape of the pawl and the teeth 126 on the rack allow the pawl 128 to slide over the teeth 126 without resistance. As the second rack comes to rest, the pawl 128 automatically drops into place, locking securely into the nearest tooth of the rack. This ensures that the ratchet mechanism resets itself without requiring manual adjustment, making the system fully automated for subsequent cleaning cycles.

The ratchet mechanism 112 enhances the system's efficiency and reliability by locking the second rack during the spring-loading phase to prevent premature energy release, ensuring full utilization of the spring's potential energy. It provides precision control by allowing the second rack to move only when the spring reaches optimal tension, resulting in consistent and reliable flipping of the mesh plate. Additionally, it minimizes wear and tear on system components, such as the second rack and gear, by controlling the timing of the release, thereby improving overall durability.

The second gear and rack mechanism 114 links the tension spring 110 to the mesh plate 116. The second rack, driven by the sudden release of potential energy from the tension spring, moves linearly. This linear motion is transferred to the second gear, which is configured to convert it into rotational motion. The rotational motion generated by the second gear causes the attached mesh plate 116 to flip rapidly from its initial position (first position) to a secondary position (second position). This abrupt flipping action is specifically dislodges the accumulated debris, such as leaves and twigs, from the mesh plate's surface, ensuring the gutter remains clear for optimal water flow. Once the flipping motion is complete, the mesh plate resets to its original position, ready for subsequent cleaning cycles.

The mesh plate 116 serves as a protective barrier positioned over the rain gutter 140 to allow rainwater to flow freely into the gutter while blocking debris such as leaves, twigs, and other obstructions. The mesh plate 116 prevents clogging while ensuring smooth water drainage. In the self-cleaning rain gutter system, the mesh plate 116 performs a flipping motion between two positions, a first position where it rests in its default state over the rain gutter 140, and a second position where it rotates to dislodge accumulated debris. This flipping motion is actuated by the second gear and rack mechanism 114, which converts the stored potential energy from the tension spring 110 into a swift rotational motion. The abrupt flipping action effectively clears the surface of the mesh plate 116, ensuring that debris is expelled without requiring manual intervention. Once the debris is dislodged, the mesh plate 116 automatically returns to its first position, ready to continue filtering water and preventing additional debris accumulation.

The automated rain gauge 118 detects rainfall and ensuring that the self-cleaning system operates efficiently during wet conditions. It comprises a container 118-1 strategically positioned to collect rainwater falling onto the roof. The container is connected to a funnel 118-2, which directs the collected water in a controlled manner toward a first sensor 118-3. The funnel 118-2 ensures that the water flow is concentrated, allowing the first sensor 118-3 to measure rainfall accurately.

The first sensor 118-3 detects the volume of rainwater passing through and generates data reflecting the intensity or amount of rainfall. This information is transmitted to the processor 104, which continuously monitors the sensor's output. If the detected rainfall exceeds a predetermined threshold indicating heavy rain conditions the processor 104 promptly activates the cleaning cycle.

The first sensor 118-3 in the automated rain gauge can utilize various sensor types based on the specific requirements. One suitable option may be a capacitive water level sensor, which measures changes in capacitance caused by the presence of water within the funnel. This type of sensor is highly accurate, can detect small volumes of water, and requires minimal maintenance. Ultrasonic sensor, may be used which uses sound waves to measure the water level or flow rate. Ultrasonic sensors are non-contact, reducing the risk of debris interfering with their operation, and they work effectively even in turbulent water conditions. A piezoelectric sensor may also be used, as it generates a voltage when subjected to water pressure or impact, providing an efficient way to measure rainfall intensity. For simpler designs, a conductivity-based sensor could be employed, where the sensor detects water through changes in electrical conductivity, making it cost-effective and reliable. Each of these sensors can be integrated with the processor to ensure precise and real-time detection of rainfall for optimal system performance.

By triggering the cleaning mechanism in response to significant rainfall, the self-cleaning rain gutter system prevents the accumulation of debris that could obstruct water flow during critical drainage periods. This automated response enhances the efficiency of the system, ensuring uninterrupted water flow and reducing the risk of gutter overflows and structural damage. The rain gauge's ability to provide real-time rain detection enables the system to adapt dynamically to environmental conditions without requiring manual intervention.

The timer 120 maintains consistent functionality regardless of weather conditions. The timer 120 generates periodic signals that are transmitted to the processor 104, prompting the activation of the motor 106 at pre-set intervals. These intervals can be programmed based on user preferences or system requirements to ensure that debris accumulated on the mesh plate 116 is dislodged regularly, even when there is no rainfall. By maintaining a periodic cleaning cycle, the timer prevents excessive build-up of debris that could hinder water flow during unexpected rain. Additionally, the timer 120 allows for optimized energy consumption by activating the motor only at specific times, avoiding unnecessary operation. This automated scheduling feature enhances the system's efficiency, ensuring the gutters remain clean and functional without manual intervention.

For the self-cleaning gutter system, timers 120 would be digital programmable timers, real-time clocks (RTC), or interval-based mechanical timers, depending on the desired level of precision and automation. Digital programmable timers are highly suitable as they allow users to set specific activation schedules, such as daily or weekly intervals, ensuring the motor 106 operates at optimal times. These timers can be integrated with the processor 104 to enable dynamic adjustments based on environmental conditions like weather patterns.

Real-time clocks (RTC) are another excellent option as they provide precise timing and can synchronize cleaning operations with real-world time, offering versatility for seasonal or time-sensitive adjustments. RTC modules are particularly useful when combined with sensors, as they allow for both time-based and condition-triggered cleaning cycles.

For simpler systems, mechanical interval timers can suffice. These timers operate by triggering the motor at fixed intervals, such as every few hours or days, without the need for complex programming. However, while mechanical timers are cost-effective and reliable, they lack the flexibility of digital options.

The second sensor 122 is strategically positioned near the mesh plate 116 to detect the positional state of the mesh plate. Specifically, the sensor identifies whether the mesh plate is in its first position (resting or operational position, where it is aligned to block debris and allow water to pass through) or its second position (flipped position, where accumulated debris is dislodged from the surface).

The second sensor 122 operates by generating a signal corresponding to the current state of the mesh plate 116. For instance, when the mesh plate 116 flips from the first position to the second position due to the energy released from the tension spring 110 via the second gear and rack mechanism 112, the sensor 122 detects this transition. The detection mechanism may involve physical contact sensing, optical sensing, or proximity-based methods, depending on the sensor type employed in the system.

The detection mechanism of the second sensor 122 may utilize various sensing technologies depending on the specific requirements and design of the self-cleaning rain gutter system. A physical contact sensor could be employed, such as a mechanical limit switch. In this configuration, the mesh plate 116 presses against the switch when it reaches the first or second position, triggering a signal to the processor 104. This type of sensor is reliable and cost-effective, making it suitable for applications where environmental factors like moisture and debris are controlled.

Alternatively, an optical sensor could be used, such as an infrared (IR) emitter and receiver pair. In this method, the sensor detects the presence or absence of the mesh plate 116 at a specific position by monitoring the interruption or reflection of the IR beam. Optical sensors are non-contact and ideal for detecting positional changes without wear and tear, but they may require additional protection to prevent interference from dirt or water splashes.

Another option may be a proximity-based sensor, such as an inductive or capacitive sensor. An inductive sensor detects the position of the mesh plate by sensing the proximity of a metallic component attached to the plate. Similarly, a capacitive sensor can detect changes in the electric field caused by the plate's movement. Proximity sensors are highly durable and can operate effectively in harsh conditions, making them suitable for outdoor applications like gutter systems.

This positional information is transmitted to the processor 104 for monitoring and control. The processor 104 uses the data to verify whether the flipping operation has been successfully completed. If the second sensor 122 does not detect the expected transition of the mesh plate 116, it may indicate that the mesh plate is obstructed, possibly due to excessive debris accumulation or mechanical failure.

The integration of the second sensor 122 ensures real-time feedback on the system's operation, enabling robust performance and reliability. It also aids in user awareness and maintenance by providing a direct method of monitoring the operational state of the mesh plate 116

The I/O device 124 enables the user to monitor the operational status of the system and issue commands to the processor 104 as needed. The input functionality may include manual controls, such as buttons, switches, or a touch-based interface, allowing users to activate specific operations of the system. For instance, a user can manually trigger the motor 106 to initiate the cleaning cycle, regardless of automated triggers such as the rain gauge 118 or the timer 120. This feature is particularly useful during dry seasons or when the user observes an accumulation of debris requiring immediate action.

The output functionality includes status indicators that provide real-time feedback about the system's performance. For example, an LED display or an LCD screen can show whether the mesh plate 116 is in its default first position or its flipped second position, based on signals received from the second sensor 122.

The display can also indicate whether the debris removal operation has been successfully completed or if the system encountered an issue, such as excessive debris weight preventing the mesh plate from flipping. Warning lights or audio alerts can notify the user of specific problems, such as motor malfunctions, sensor errors, or a blocked mesh plate. Advanced I/O implementations may include wireless connectivity, such as a mobile app or web interface, to allow users to monitor and control the system remotely. Through this interface, users could receive alerts, review system logs, and even adjust parameters like the timer 120 interval or the rain threshold for activation.

The I/O device 124 may include suitable logic, circuitry, interfaces, and/or code that may be configured to receive an input and provide an output based on the received input. For example, the I/O device 124 may receive a first user input indicative of a request to convert the source audio. The first user input may include the source audio. For example, the I/O device 124 may include a microphone through which the user may record a voice of the user as the source audio. Alternatively, the source audio may be selected by the user from a set of audio files stored on the electronic device. The I/O device 124 may be further configured to render the converted audio. Examples of the I/O device 124 may include, but are not limited to, a display (e.g., a touch screen), a keyboard, a mouse, a joystick, a microphone, or a speaker. Examples of the I/O device 124 may further include braille I/O devices, such as, braille keyboards and braille readers.

The combination of manual inputs and visual or auditory outputs ensures that the system remains intuitive and easy to use while maintaining operational transparency. This functionality allows users to take proactive steps for maintenance or manual intervention when necessary, thereby enhancing the overall reliability and convenience of the self-cleaning rain gutter system.

FIG. 2 illustrates example scenarios of a mesh plate in a first position, in accordance with an embodiment of the present disclosure. With reference to the FIG. 2, exemplary scenarios 200-1 and 200-2 of the mesh plate 116 in a first position is illustrated. In this configuration, the mesh plate 116 lies flat over the rain gutter 140, allowing rainwater to pass through while blocks debris from entering the gutter. This default position is maintained until the self-cleaning gutter system is triggered to clean the mesh plate 116.

The shaft 134 of the motor 106 is coupled to the first gear 108-1 of the first gear and rack mechanism 108. More specifically, the exemplary scenario 200-1 illustrates a case where the motor 106 has not yet been activated by the processor 104. In the scenario 200-1, when the motor is not activated by the processor 104, the rack 108-2 of the first gear and rack mechanism 108 is in its rest or normal or default position, causing the tension spring 110 to remain in its unstretched normal position, storing no potential energy in this default state. The mesh plate 116 receives no force or actuation from the tension spring to change its position in this case.

In the scenario 200-2, the processor 104 activates the motor 106. The activation of the motor 106 may be caused due to one or more factors. In an example, the processor 104 may activate the motor 106 when the rain detected by the automated rain gauge 118 is greater than a predefined threshold amount. In another example, the processor 104 may activate the motor 106 periodically using the timer 120. In the scenario 200-2, when the motor 106 is activated, the shaft 134 of the motor 106 rotates clockwise, thus causing the gear 108-1 to rotate clockwise. This clockwise rotation of the gear 108-1 cause the first rack 108-2 to move towards the left, thus causing the tension spring 110 to stretch towards the left. The first gear 108-1 and the first rack 108-2, driven by the motor 106, applies a force F₁ on the tension spring 110. This force stretches the spring, storing potential energy in the form of elastic deformation, as described by Hooke's Law (F₁=k.x) where k represents the spring constant, and x is the elongation of the spring. The ratchet mechanism 112 ensures that the second rack 114-2 of the second gear and rack mechanism 114 is temporarily locked in place, preventing the mesh plate 116 from flipping until sufficient force is generated. The ratchet mechanism 112 temporarily locks the second rack in position, exerting a resistive force F₂ that prevents premature movement of the second rack and second gear. The ratchet mechanism 112 ensures the spring tension reaches a critical threshold before allowing energy release. This controlled locking mechanism guarantees that the energy stored in the spring is sufficient to execute the flipping motion of the mesh plate reliably. In the scenario 200-2, the force F₂>F₁, thus preventing the movement of the second rack 114-2 towards the left. This way, the force F₁ stored in the tension spring 110 generated due to the motor movement is not transmitted to the mesh plate 116. Thus, keeping the mesh plate 116 in the first position in the scenario 200-2 even after the movement of the motor 106.

The second sensor 122 detects that the mesh plate 116 is in the first position and transmits this information to the processor 104. The processor 104, which serves as the control unit, monitors the system status and coordinates operations. The motor can be triggered by the timer 120 or by user input via I/O devices 124 to initiate the cleaning cycle. Additionally, signals from the automated rain gauge 118 may also activate the motor when excessive rainfall is detected, ensuring that debris is removed before it obstructs water flow.

As shown in FIG. 2, the second gear 114-1 is directly coupled to the mesh plate 116 with the help of a hinge 142, enabling its movement in response to the activation of the motor 106. This coupling allows the second gear 114-1 to transfer motion to the mesh plate 116 for flipping and dislodging debris. Additionally, the second rack 114-2, which is integral to the second gear and rack mechanism 114, is connected to the second end of the tension spring 110. This connection ensures that the tension spring 110 applies a controlled force on the second rack 114-2, facilitating its bi-directional movement during the cleaning operation. The coupling arrangement between the second rack 114-2, second gear 114-1, and tension spring 110 allows the system to efficiently accumulate and release energy, driving the movement of the mesh plate 116 to achieve effective self-cleaning.

In an example configuration, the automated rain gauge 118 may include a container 118-1, funnel 118-2, and first sensor 118-3, which collectively detect rainfall and send data to the processor 104. In the absence of rainfall, the mesh plate 116 remains in the first position to allow the unobstructed flow of water through the gutter system. If no external triggers are received, the system conserves energy by maintaining this default state.

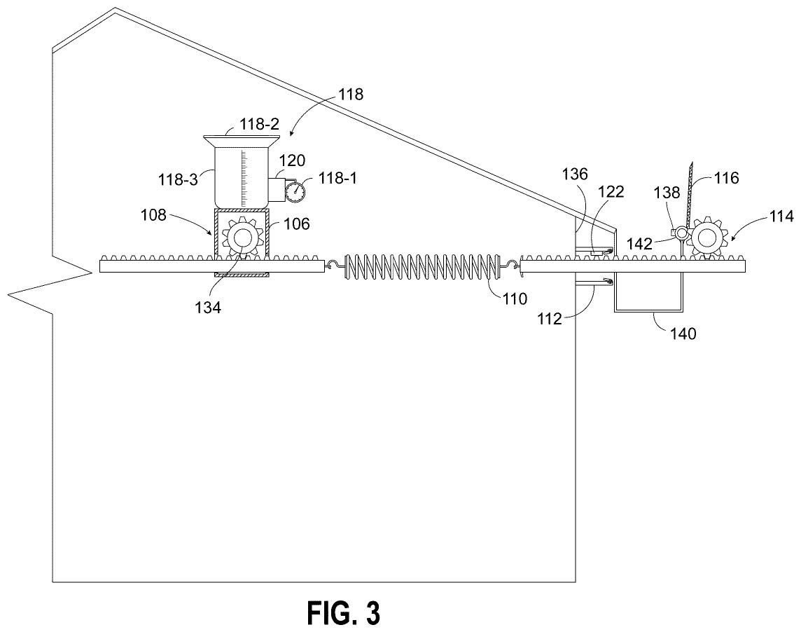

FIG. 3 illustrates an exemplary scenario of a mesh plate in a second position, in accordance with an embodiment of the present disclosure. With reference to the FIG. 3, an exemplary scenario 300 of the mesh plate 116 in a second position is illustrated. The flipping mechanism of the mesh plate 116 is governed by the interplay of the forces F₁, F₂ and the spring constant (k) of the tension spring 110. In an example, as the shaft 134 of the motor 106 rotates clockwise, the gear 108-1 also rotates clockwise. This clockwise rotation of the gear 108-1 cause the first rack 108-2 to move towards the left, thus causing the tension spring 110 to stretch towards the left. The first gear 108-1 and the first rack 108-2, driven by the motor 106, applies a force F₁ on the tension spring 110. This force F1 stretches the tension spring 110, storing similar potential energy in the form of elastic deformation. The second rack 114-2 is held by the ratchet mechanism 112 to resist movement towards the left.

The ratchet mechanism 112 temporarily locks the second rack in position, exerting a resistive force F₂ that prevents premature movement of the second rack and second gear. In the scenario 300 (F₂<F₁), when the tension F1 in the tension spring 110 crosses the resistive force F₂ of the ratchet mechanism 112, the ratchet mechanism 112 releases its hold on the second rack 114-2. The tension spring 110 then retracts rapidly towards its normal unstretched position, imparting linear motion to the second rack 114-2. The linear displacement of the second rack 114-2 is converted into rotational motion by the second gear 114-1, creating a torque that flips the mesh plate 116 from its first position to its second position. This torque is in the form of a sudden jerk, thus causing this flipping action to effectively dislodge accumulated debris from the surface of the mesh plate, ensuring the rain gutter 140 remains clear for proper water drainage.

In cases where significant debris is present on the mesh plate 116, the weight of the debris introduces an additional resistive force, F_{debris}, acting downward due to gravity. This force increases the total resistance the spring must overcome to flip the mesh plate. The combined resistive force becomes

Fₜₒₜₐₗ=F₂+F_{debris} (1)

If the spring's applied force F₁ does not exceed Fₜₒₜₐₗ, the mesh plate 116 remains stationary, and the attempt to flip the mesh plate 116 fails. This prevents excessive strain on the system components, such as the gears and racks, and avoids potential mechanical damage due to overloading. To combat such conditions, the force F₁ may be controlled as per the combined resistive force F_{Total}.

In an alternative embodiment, the above problem may be solved by enhancing the ratchet mechanism 112 with electronic control to dynamically adjust the holding and release forces based on the weight of the debris accumulated on the mesh plate 116. This modification replaces or augments the traditional mechanical ratchet with an electronically controlled system. The ratchet mechanism 112 may additionally include an electromagnetic actuator 132 that is triggered based on signals from a processor 104. The pawl 128 of the ratchet mechanism 112 engages with the teeth 126 of the second rack 114-2 to lock it in place while the spring tension builds up. The pawl's locking force may be controlled by the electromagnetic actuator 132 that adjusts based on signals from the processor 104. This adjustment ensures the second rack 114-2 remains securely locked during spring tensioning, even as debris weight fluctuates. More details of the ratchet mechanism 112 modified for this embodiment can be found further with reference to description of scenario 400-2 of FIG. 4 and scenario 500-2 of FIG. 5.

The processor 104 may use load sensor 138 to continuously monitor the debris weight, strategically placed near the mesh plate 116. This load sensor 138 measures the additional force exerted by the debris and sends this data to the processor 104, which calculates the required spring tension. The processor 104 then dynamically adjusts the holding force applied by the electromagnetic actuator 132 to ensure the second rack 114-2 is securely locked until the necessary spring tension is achieved. This real-time adjustment helps prevent premature release or insufficient locking, ensuring the spring tension is properly accumulated for effective mesh plate 116 flipping.

The release mechanism is activated once the spring tension reaches the calculated level based on the debris weight. At this point, the processor 104 signals the electromagnetic actuator 132 to momentarily disengage the pawl 128, allowing the stored spring energy in the form of potential energy to be released and flip the mesh plate. In cases where the debris weight exceeds the system's capacity, an alarm device, such as a buzzer or LED indicator, is triggered to alert the user. This ensures manual intervention if necessary, preventing damage to the system. Additionally, the system includes a calibration process for the weight sensor to account for environmental factors like wind or water flow, ensuring accurate weight measurement.

Additionally a second sensor 122 is integrated to monitor and determine the position of the mesh plate 116, specifically whether it is in the first position or the second position. The second sensor 122 is operatively connected to the processor 104, allowing it to transmit real-time position data of the mesh plate 116 to the processor 104. This sensor 122 ensures that the self-cleaning rain gutter system can confirm the success of the flipping operation and provide feedback for subsequent actions.

The second sensor 122 may be implemented using various technologies, such as limit switches, optical sensors, or magnetic position sensors. For instance, a limit switch could be positioned to make contact with the mesh plate in its first and second positions, triggering an electrical signal corresponding to each state. Alternatively, an optical sensor could detect the plate's position based on light interruption or reflection, while a magnetic position sensor could use magnets attached to the mesh plate and a magnetic field detector to ascertain its position.

When the motor 106 activates the first gear and rack mechanism 108 to stretch the tension spring 110, the second sensor 122 continuously or periodically checks the position of the mesh plate to confirm its state. Upon release of the stored energy in the spring, the flipping motion drives the mesh plate from the first position to the second position. The second sensor 122 then signals the processor 104 once the mesh plate 116 has reached the flipped position, ensuring proper operation and enabling the processor 104 to reset the system for the next cycle.

If the mesh plate 116 fails to move to the second position due to excessive debris weight or mechanical obstruction, the second sensor 122 communicates to the processor 104. The processor 104, in turn, can activate an alert may be an alarm device or a notification through the input/output (I/O) devices 124, informing the user of the issue. By ensuring the mesh plate's position is accurately monitored and reported, the second sensor 122 enhances the reliability and efficiency of the automated self-cleaning gutter system.

In an embodiment, the input/output (I/O) devices 124 may be a display device is incorporated within the user's premises to provide visual feedback about the current position of the mesh plate 116. The display device is operatively connected to the processor 104, which receives data from the second sensor 122 and transmits corresponding information to the display device. This configuration ensures that the user is informed in real-time whether the mesh plate is in the first position or the second position.

The processor 104 processes the signals received from the second sensor 122, which continuously monitors the position of the mesh plate. If the mesh plate remains in the first position, the processor 104 sends a signal to the display device, indicating that the mesh plate is in its default state and the gutter is ready to collect rainwater. When the tension spring 110 releases its stored energy, flipping the mesh plate to the second position, the second sensor 122 detects the change and relays this information to the processor. The processor 104 then updates the display device to indicate that the mesh plate 116 has transitioned to the open position, effectively clearing debris.

The display device may be implemented using various technologies, such as an LCD screen, LED panel, or touch screen interface, and may be installed in a convenient location within the user's premises. For example, the display could show simple text messages such as “Mesh Plate: Closed” or “Mesh Plate: Flipped,” or use graphical icons to represent the two positions. Additionally, the display device could include a user-friendly interface that allows users to access system diagnostics or receive maintenance alerts if the flipping mechanism fails to function properly due to excessive debris weight or mechanical obstruction.

By integrating the display device, the self-cleaning gutter system ensures that users are kept informed of the operational status of the mesh plate 116 without requiring physical inspection of the gutter system. This feature not only enhances user convenience but also improves the system's reliability by providing actionable feedback in the event of a malfunction.

FIG. 4 illustrates ratchet mechanism in the self-cleaning rain gutter system of FIG. 1, in accordance with an embodiment of the present disclosure. FIG. 4 illustrates scenarios 400-1 and 400-2 for the self-cleaning gutter system.

Scenario 400-1 illustrates operational engagement of the pawl 128 with the sloped teeth 126 of the second rack 114-2 in accordance with an embodiment. In this state, the pawl 128 locks the second rack 114-2 in position, ensuring stability during the accumulation of tension in the spring 110. The sloped teeth 126 are angled at a specific angle X to facilitate smooth locking, allowing the pawl 128 to secure the second rack 114-2 against unintended movement. This phase is critical for building the potential energy required for the flipping action, and the durable construction of the pawl 128 ensures reliable engagement during repeated operations.

Scenario 400-2 illustrates another embodiment where teeth 126 of the second rack 114-2 are shaped like a sawtooth wave in which alternative edges of the teeth 126 are orthogonal to a base of the second rack 114-2. This sawtooth wave shaped teeth 126 ensures complete locking of the teeth 126 of the second rack 114-2 by the pawl 128. More details of the complete locking of the teeth 126 by the pawl is illustrated further in scenario 500-2 of FIG. 5. This complete locking ensures no release of the second rack 114-2 even after application of any amount of tension force F₁ by the tension spring 110.

For the case where debris present on the mesh plate 116 introduces an additional resistive force (F_{debris}), the combined resistive force becomes Fₜₒₜₐₗ=F₂+F_{debris}. This case demands the force F₁ to be greater than Fₜₒₜₐₗ. In the scenario 400-2, the load sensor 138 may send signal to the processor 104 whenever the weight sensed by the load sensor 138 crosses a threshold value. Based on the signal received from the load sensor 138, the processor 104 may trigger the actuator 132 to lift the pawl 128 only when the force F₁ becomes greater than Fₜₒₜₐₗ, allowing the second rack 114-2 to move freely in the desired direction and thus flipping the mesh plate 116 with the force necessary to overcome the weight of the debris.

FIG. 5 illustrates operational configurations of a rack and a pawl in the ratchet mechanism of FIG. 4, in accordance with an embodiment of the present disclosure. FIG. 5 illustrates scenarios 500-1 and 500-2 to illustrate different shapes of the teeth 126 of the second rack 114-2 and associated components of the ratchet mechanism 112 in the self-cleaning gutter system. These scenarios demonstrate the functionality of the pawl 128 in engaging with the sloped teeth 126 of the second rack 114-2 under varying conditions, showcasing both partial or temporary locking(in the scenario 500-1) and complete locking of the rack (in the scenario 500-2).

Scenario 500-1 depicts the engagement of the pawl 128 with the sloped teeth 126 at an angle X with respect to a base of the second rack 114-2. In this configuration, the slope of the teeth 126 facilitates controlled movement of the second rack 114-2 as influenced by the force generated by the tension spring 110. Due to the slope of the teeth engaging the pawl 128, at least a specific amount of force (from the tension spring 110) is required to disengage the pawl from the sloped teeth. This disengagement of the teeth 126 from the pawl 128 results in unlocking of the movement of the second rack 114-2 under the effect of the force stored in the stretched tension spring 110. Thus, the second rack 114-2 moves with a jerk to flip the mesh plate 116. This operational mode is essential for the dynamic adjustments of the rack during the spring-tensioning and flipping phases, ensuring efficient system performance.

Scenario 500-2 illustrates a locking configuration where the pawl 128 engages with the sawtooth wave shaped teeth 126 of the second rack 114-2. In this position, the pawl 128 firmly locks the second rack, preventing any movement in either direction. This mode is crucial for maintaining the system in a stable state, such as during the case when the weight of the debris prevents the movement of the mesh plate 116. As explained in the scenario 400-2 of FIG. 4, the pawl 128 is disengaged from the teeth 126 by the actuator 132 which is controlled by the processor 104 based on the debris weight on the mesh plate 116 is greater than a threshold weight.

Scenarios 500-1 and 500-2 demonstrate the versatility of the ratchet mechanism 112 in managing the second rack's movement. FIG. 500-1 highlights the system's ability to temporarily hold the second rack 114-2, thus, creating a tension in the spring 110 to produce a sudden jerk for flipping the mesh plate 116, while scenario 500-2 ensures a locked and stable configuration when required to accumulate even greater tension in the spring 110 as compared to the scenario 500-1. The actuator 132 may be used in this scenario 500-2 to disengage the pawl 128 from the teeth 126 of the second rack when sufficient tension is accumulated in the tension spring 110. This dual functionality enhances the adaptability and reliability of the self-cleaning gutter system, contributing to its overall operational efficiency.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A self-cleaning gutter system for removing debris from a rain gutter, comprising:
a mesh plate positioned over the rain gutter to prevent debris from entering the rain gutter while allowing water to pass through;
a motor operatively connected to the mesh plate;
a tension spring;
a first gear and rack mechanism comprising a first gear and a first rack, wherein
the first gear and rack mechanism is coupled to the motor via the first gear and coupled to a first end of the tension spring via the first rack, and
the first gear and rack mechanism is configured to convert rotational motion of the motor into linear motion to stretch the tension spring and store potential energy therein;
a second gear and rack mechanism comprising a second gear and a second rack, wherein
the second gear and rack mechanism is coupled to the mesh plate via the second gear and coupled to a second end of the tension spring via the second rack, and
the second gear and rack mechanism is configured to convert linear motion from the tension spring into rotational motion of the second gear to rotate the mesh plate;
a ratchet mechanism operatively connected to the second rack, wherein the ratchet mechanism is configured to:
temporarily lock the second rack in place as the tension spring is stretched by the first gear and rack mechanism, thereby preventing the movement of the second rack while the tension spring accumulates potential energy; and
release the second rack upon reaching a predetermined tension in the tension spring, thereby allowing the stored energy to be released abruptly to create a sudden linear motion in the second rack, which rotates the second gear and flips the mesh plate from a first position to a second position, thereby dislodging debris from the mesh plate; and
a processor configured to activate the motor to initiate the stretching of the tension spring, wherein
upon activation by the processor, the motor rotates the first gear and rack mechanism, which stretches the tension spring to accumulate potential energy, and upon release by the ratchet mechanism, the tension spring contracts to create a sudden linear movement in the second rack, flipping the mesh plate to dislodge the debris.

2. The system of claim 1, further comprising an automated rain gauge that includes
a container positioned to collect rainwater,
a funnel directing the collected rainwater from the container to a first sensor, and
the first sensor configured to detect the amount of rain and output information associated with the amount of rain to the processor.

3. The system of claim 2, wherein the processor is further configured to activate the motor based on the detected amount of rain is greater than a threshold amount of rain.

4. The system of claim 1, further comprising a timer operatively connected to the processor, wherein the timer is configured to periodically signal the processor to activate the motor at set intervals, thereby ensuring regular flipping of the mesh plate to dislodge debris from the gutter even when rain is not detected.

5. The system of claim 4, wherein the processor is further configured to activate the motor at the set intervals signalled by the timer.

6. The system of claim 1, wherein the processor is further configured to activate the motor based on a user input.

7. The system of claim 1, further comprising an alarm device configured to emit an audio alert when the mesh plate is unable to flip due to excessive weight from accumulated debris.

8. The system of claim 1, further comprising a second sensor configured to determine whether the mesh plate is in the first position or the second position.

9. The system of claim 8, further comprising a display device located within a user's premises, wherein the processor is further configured to control the display device to display whether the mesh plate is in the first position or the second position.
